(19) United States
(12) Patent Application Publication
(10) Pub. No.: US 2024/0399695 A1
(43) Pub. Date: Dec. 5, 2024

(54) Hand Roller

(71) Applicant: Phoenix Aerospace Corporation, Richland Hills, TX (US)

(72) Inventor: James Decker, Richland Hills, TX (US)

(21) Appl. No.: 18/432,365

(22) Filed: Feb. 5, 2024

Related U.S. Application Data
(60) Provisional application No. 63/443,157, filed on Feb. 3, 2023.

(51) Int. Cl. B30B 3/00

(52) U.S. Cl. CPC B30B 3/005

(57) ABSTRACT

A hand roller (100) for application of pressure to a surface. The hand roller comprises a handle (102) rigidly secured to a roller frame (104). A roller cylinder (106) is rotatably secured to the roller frame (104). The roller frame (104) features an upper pressure surface (120) having an ergonomic shape to facilitate the application of enhanced pressure on the roller cylinder (106).

### FIELD OF THE INVENTION

The present disclosure is directed generally to hand tools and in particular to a hand roller providing for the application of enhanced roller pressure in an ergonomic manner.

### SUMMARY OF THE INVENTION

The present disclosure is directed to a hand roller for application of pressure to a surface. The hand roller comprises a handle rigidly secured to a roller frame. A roller cylinder is rotatably secured to the roller frame. The roller frame features an upper pressure surface having an ergonomic shape to facilitate the application of enhanced pressure on the roller cylinder.

According to certain embodiments the upper pressure surface may have at least one planar portion, at least one curved portion, or both. The upper pressure surface may have multiple curved portions. In one embodiment, the upper pressure surface has a planar surface and two curved surfaces. The first and second curved portions of the upper pressure surface may be disposed on opposite sides of the planar portion.

In certain embodiments, the handle has a principal axis and the planar portion of the upper pressure surface is disposed at an angle to the principal axis of the handle, or to a plane parallel to both the principal axis of the handle and the axis of rotation of the roller cylinder. This angle may have a value between 0 and 45 degrees. In certain embodiments, the angle is between 20 and 30 degrees or more specifically between 22 and 26 degrees. In one embodiment, the angle is approximately 24 degrees.

### BRIEF DESCRIPTION OF THE DRAWING FIGURES:

The foregoing disclosure will be best understood, and the advantages thereof made most clearly apparent, when consideration is given to the following detailed description in combination with the drawing figures presented. The detailed description makes reference to the following drawings:

FIG. 1A is a front-right-top oblique view of a hand roller according to the present disclosure;

FIG. 1B is a top view of the hand roller of FIG. 1A;

FIG. 1C is a front view of the hand roller of FIGS. A1 and 1B;

FIG. 1D is a right side view of the hand roller of FIGS. 1A-1C;

FIG. 2 is an exploded oblique view of the hand roller shown in FIGS. 1A-1D;

FIG. 3A is a front-left-top oblique view of a roller frame according to the present disclosure;

FIG. 3B is a front-right-top oblique view of the roller frame of FIG. 3A;

FIG. 3C is a top view of the roller frame of FIGS. 3A and 3B;

FIG. 3D is a left side view of the roller frame of FIGS. 3A-3C;

FIG. 3E is a front end view of the roller frame of FIGS. 3A-3D;

FIG. 3F is a right side view of the roller frame of FIGS. 3A-3E;

FIG. 3G is a bottom view of the roller frame of FIGS. 3A-3F; and

FIG. 4 is a top view of the roller frame of FIGS. 3A-3G prior to bending.

### DETAILED DESCRIPTION OF THE INVENTION

The following detailed description provides certain specific embodiments of the subject matter disclosed herein. Although each embodiment represents a single combination of elements, the subject matter disclosed herein should be understood to include sub-combinations of the disclosed elements. Thus, if one embodiment comprises elements A, B, and C, and a second embodiment comprises elements B and D, then the inventive subject matter is also intended to include other remaining combinations of A, B, C, or D, even if not explicitly disclosed herein.

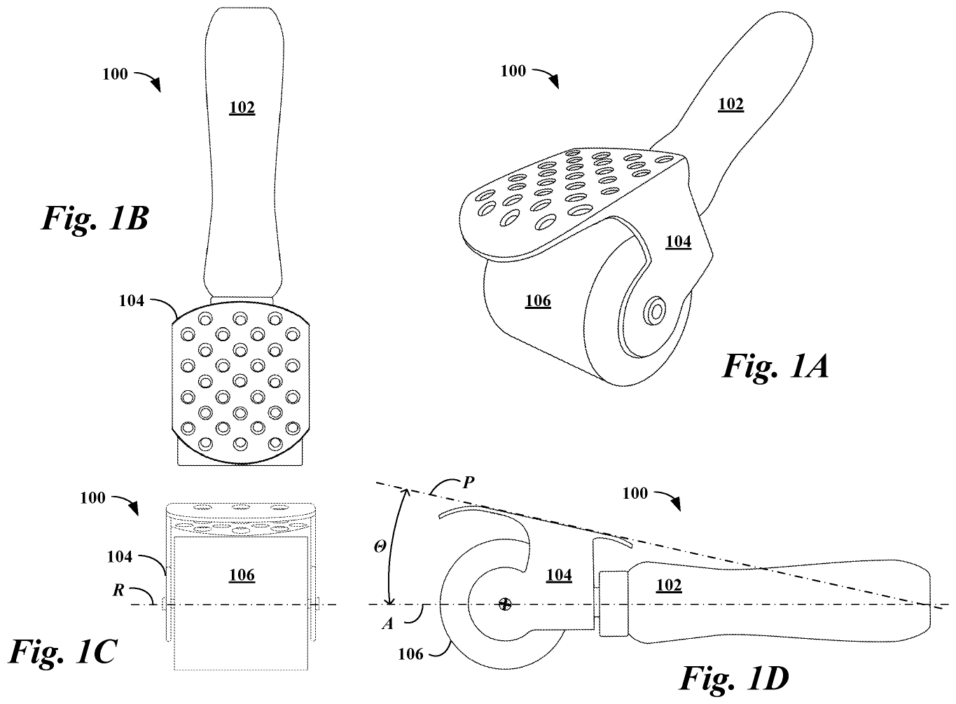

FIGS. 1A-1D are oblique, top, front and right side views of a hand roller 100 according to the present disclosure. Hand roller 100 comprises handle 102, securely connected to roller frame 104. Roller cylinder 106 is contained inside roller frame 104 in such manner as to be freely rotatable within roller frame 104, as described in further detail below.

Roller cylinder 16 revolves around axis of rotation R. Handle 102 has a principal dimension, with axis A running generally lengthwise along the center of the principal dimension. In the embodiment shown in FIG. 1D, axis A intersects the axis of rotation R orthogonally in the center of roller cylinder 106. In alternate embodiments, axis R and axis A may not intersect. In the embodiment shown in FIG. 1D, the upper surface of roller frame 104 incorporates a generally-planar portion disposed at an angle θ to the common plane of axis A and axis R. In one embodiment, angle θ is approximately 24 degrees. In alternate embodiments, angle θ may vary from 0 to 45 degrees.

Handle 102 may be constructed from a variety of suitable materials, including polymers, wood, metals or composite materials known to be suitable for the construction of handles. Roller frame 104 may be constructed from any suitable material providing sufficient strength and durability, but the embodiment described herein incorporates a roller frame 104 constructed of metal, and specifically ductile sheet steel. In a similar manner, roller cylinder 106 may be constructed from a range of materials, including rigid polymers, elastomeric polymers, metals and composites. In certain embodiments, roller cylinder 106 is constructed from an elastomeric shell disposed around a rigid core.

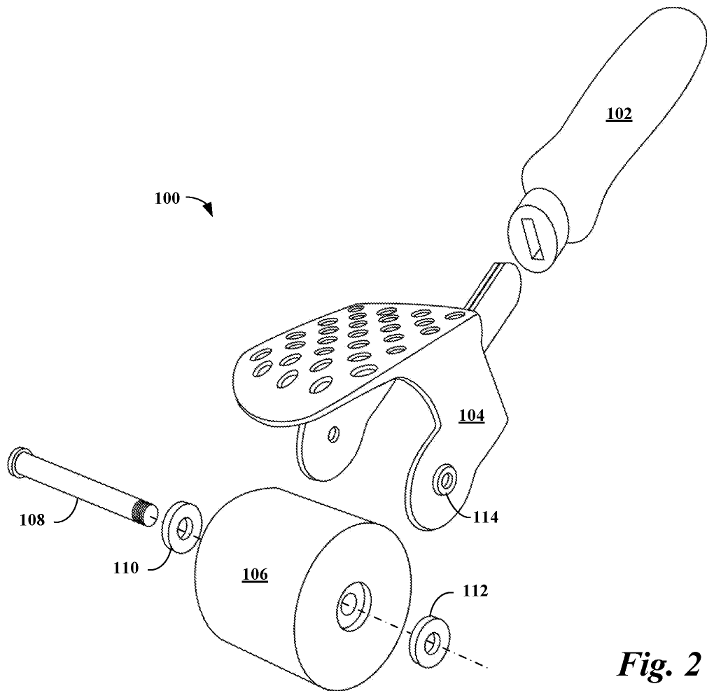

FIG. 2 is an exploded oblique view of hand roller 100 shown in FIGS. 1A-1D. This view provides addition detail as to the rotatable connection between roller frame 104 and roller cylinder 106. Rotation is facilitated by roller axle 108, which passes through a first side of roller frame 104, thrust bearing 110, roller cylinder 106, thrust bearing 112 and threaded nut 114 disposed in the opposite side of roller frame 104. This construction allows roller cylinder 106 to rotate freely within roller frame 104. The material chosen for roller axle 108 may vary by application. In one embodiment, roller axle 108 is made from high-strength steel.

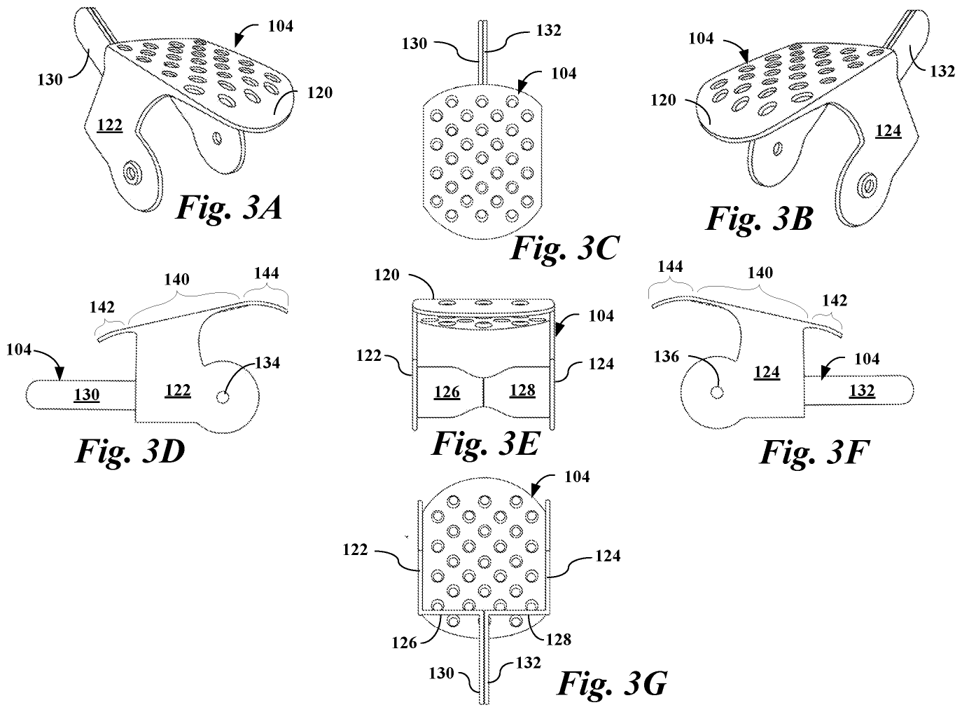

FIGS. 3A-3G show oblique, top, left side, front end, right side and bottom views of roller frame 104 according to the present disclosure. Roller frame 104 incorporates upper pressure pad 120 connected at its edges to left side panel 122 and right side panel 124. Left side panel 122 is connected at its rear edge to left rear panel 126. Right side panel 124 is connected at its rear edge to right rear panel 128. The inside edge of left rear panel 126 is connected to left rear tang 130, which extends back from left rear panel 126 along the center of roller frame 104. The inside edge of right rear panel 128 is connected to right rear tang 132, which extends back from right rear panel 128 facing left rear tang 130 along the center of roller frame 104. Left annulus 134 and right annulus 136 are disposed in the center of left side panel 120 and right side panel 122, respectively. Upper pressure pad 120 incorporates planar central portion 140, curved posterior portion 142 and curved anterior portion 144, which are shaped and sized primarily according to ergonomic considerations.

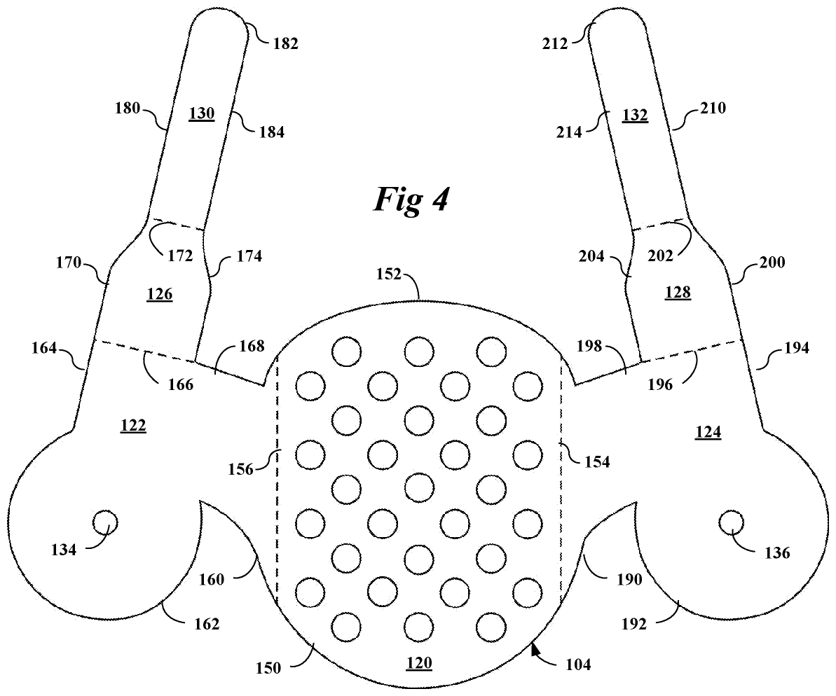

FIG. 4 is a top view of the roller frame 104 of FIGS. 3A-3G prior to bending. Upper pressure pad 120 comprises anterior edge 150, posterior edge 152, right bend line 154 adjacent to right side panel 124 and left bend line 156 adjacent to left side panel 122.

Along the left side of roller frame 104, left side panel 122 comprises left bend line 156 adjacent to upper pressure pad 120, front sigmoid edge 160, radius 162 about annulus 134, lower straight edge 164, rear bend line 166 adjacent to left rear panel 126 and rear edge 168. Left rear panel 126 comprises rear bend line 166 adjacent to left side panel 122, lower sigmoid edge 170, rear bend line 172 adjacent to rear tang 130, and upper sigmoid edge 174. Left rear tang 130 comprises rear bend line 172 adjacent to left rear panel 126, lower straight edge 180, rear radius 182 and upper straight edge 184.

Along the right side of roller frame 104, right side panel 124 comprises right bend line 154 adjacent to upper pressure pad 120, front sigmoid edge 190, radius 192 about annulus 136, lower straight edge 194, rear bend line 196 adjacent to right rear panel 128 and rear edge 198. Right rear panel 128 comprises rear bend line 196 adjacent to right side panel 124, lower sigmoid edge 200, rear bend line 202 adjacent to rear tang 132, and upper sigmoid edge 204. Right rear tang 132 comprises rear bend line 202 adjacent to right rear panel 128, lower straight edge 210, rear radius 212 and upper straight edge 214.

The foregoing summary, as well as the following detailed description of certain embodiments of the present disclosure, will be better understood when read in conjunction with the appended drawings. For the purpose of illustrating the disclosure, certain embodiments are shown in the drawings and described herein. It should be understood, however, that the present disclosure is not limited to the arrangements and instrumentalities shown in the attached drawings.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refers to at least one of something selected from the group consisting of A, B, C . . . and N, the text should be interpreted as requiring only one element from the group, not A plus N, or B plus N, etc.

1. A hand roller comprising:
a handle;
a roller frame, having an upper pressure surface, securely fixed to the handle;
a roller cylinder, rotatably coupled to the roller frame.

2. The hand roller of claim 1, wherein the upper pressure surface has a planar portion.

3. The hand roller of claim 1, wherein the upper pressure surface has a first curved portion.

4. The hand roller of claim 3, wherein the upper pressure surface has a planar portion.

5. The hand roller of claim 4, wherein the upper pressure surface has a second curved portion.

6. The hand roller of claim 5, wherein the first and second curved portions of the upper pressure surface are disposed on opposite sides of the planar portion.

7. The hand roller of claim 1, wherein the handle has a principal axis and the planar portion of the upper pressure surface is disposed at an angle to the principal axis of the handle.

8. A hand roller comprising:
a handle having a principal axis along its major dimension;
a roller frame, having an upper pressure surface having a planar portion lying in a principal plane, securely fixed to the handle;
a roller cylinder, having an axis of rotation, rotatably coupled to the roller frame.

9. The hand roller of claim 8, wherein the principal plane of the upper pressure surface is disposed at an angle to a plane parallel to both the principal axis of the handle and the axis of rotation of the roller cylinder.

10. The hand roller of claim 9, wherein the angle is between 0 and 45 degrees.

11. The hand roller of claim 9, wherein the angle is between 20 and 30 degrees.

12. The hand roller of claim 9, wherein the angle is between 22 and 26 degrees.

13. The hand roller of claim 9, wherein the angle is approximately 24 degrees.

14. The hand roller of claim 8, wherein the upper surface has a first curved portion adjacent to the planar portion.

15. The hand roller of claim 14, wherein the upper surface has a second curved portion adjacent to the planar portion and opposite the first curved portion.
